(19) United States
(12) Patent Application Publication
(10) Pub. No.: US 2011/0155039 A1
(43) Pub. Date: Jun. 30, 2011

(54) SYSTEM AND METHOD FOR DEPLOYING AND RETRIEVING A WAVE ENERGY CONVERTER

(76) Inventor: Sean Derek Moore, Gosnells (AU)

(21) Appl. No.: 12/937,451

(22) PCT Filed: Apr. 9, 2009
(86) PCT No.: PCT/AU2009/000429

§ 371 Date: Dec. 27, 2010

(30) Foreign Application Priority Data
Apr. 11, 2008 (AU) 2008901736

(51) Int. Cl. B63G 8/04; F03B 13/10

(52) U.S. Cl. 114/326

(57) ABSTRACT

A system for deploying a wave energy converter including a submersible structure having a buoyancy chamber sufficiently large that when filled with gas it enables the submersible structure to float. The wave energy converter is transported to a site on the submersible structure and launched by releasing the gas from the buoyancy chamber. The system also includes three tethers operatively coupled to the submersible structure for tethering the wave energy converter to the submersible structure; and a docking station provided in connection with the submersible structure for mechanically coupling the wave energy converter to the submersible structure during transportation.

### FIELD OF THE INVENTION

The present invention relates to wave energy converters for converting ocean wave energy into electrical energy, and relates more particularly to a system and method for transporting, launching, mooring and retrieving a wave energy converter (WEC).

### BACKGROUND TO THE INVENTION

The commissioning of a WEC is proving to be a time-consuming, expensive and dangerous logistical operation in which it is necessary to wait for the best possible launching conditions prior to the launch. This can cause lengthy delays and cost over-runs as there is no guarantee of when appropriate weather and ocean conditions will occur. WECs are ideally deployed to hostile locations with large waves and therefore there may be significant safety and damage-control problems that need to be overcome during a WEC launch or retrieval.

When the water depth is less than half the wavelength of an ocean wave the energy within the wave is attenuated due to frictional losses between the ocean bottom and the motion of the water particles within the wave. In view of this energy density variation characteristic the best place to install a WEC is far offshore where the frictional losses are negligible. However the practices currently adopted for launching a WEC inherently preclude the placement of a WEC in deep water (>50 m) as the WEC and its moorings need to remain at depths easily accessible to divers. It is possible to use divers below a 50 m depth however a saturation diver is needed at these depths. Saturation diving requires highly specialized underwater facilities and large acclimatization times in which there is no work being done; consequently this type of diving is extremely expensive. These factors make the cost of saturation divers prohibitive and as a result current WECs are deployed into shallower, less energy dense, waters accessible to commercial divers.

Current practices for launching a WEC typically involve a combination of large vessels with cranes and other highly specialized and expensive equipment, and the previously mentioned commercial divers. Commercial diving is a specialized profession which involves great risk to human life and is therefore understandably costly. All these issues add greatly to the cost, complexity and personal-injury risk of extracting energy from the ocean. Consequently if wave energy is to play a part in the coming renewable energy future of the world it would be preferable to avoid them.

The present invention was developed with a view to providing a system and method for deploying and/or retrieving a WEC in a wide variety of sea-states and weather conditions without the use of commercial divers.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided a system for deploying a wave energy converter, the system comprising:

a submersible structure having a buoyancy chamber sufficiently large that when filled with gas it enables the submersible structure to float wherein, in use, a wave energy converter can be transported to a site on the submersible structure and launched by releasing the gas from the buoyancy chamber;

a tethering means operatively coupled to the submersible structure for tethering the wave energy converter to the submersible structure; and,

a docking station provided in connection with the submersible structure for mechanically coupling the wave energy converter to the submersible structure during transportation.

Preferably the submersible structure is a barge structure having a plurality of buoyancy chambers provided therein. Preferably the barge structure has a plurality of tow points provided thereon to enable it to be coupled to a marine vessel for towing the barge structure out to sea.

The barge structure preferably further comprises a ballast with sufficient mass to act as a clump weight mooring for the wave energy converter when the buoyancy chambers have been evacuated.

The tethering means preferably comprises a plurality of tethers. The tethers are preferably used to connect the wave energy converter to the barge structure thus allowing the barge structure to act as a mooring means when it is submerged. The tethering means preferably further comprises a plurality of tether winding assemblies for winding the respective tethers during deployment or retrieval of the wave energy converter. Each tether winding assembly preferably comprises a spindle or winch on which a respective tether is wound. The spindle/winches are used to keep a specific tension on the tethers during the submersion and resurfacing of the barge structure.

Preferably the docking station incorporates a guiding means that will facilitate automatic alignment of the wave energy converter to the docking position in the docking station. In a preferred embodiment the guiding means comprises a plurality of projecting alignment guides which also act to inhibit horizontal movement of the wave energy converter in the docking position.

According to another aspect of the present invention there is provided a method of deploying a wave energy converter, the method comprising the steps of:

docking a wave energy converter in a docking station provided in connection with an upper surface of a submersible structure, the docking station mechanically coupling the wave energy converter to the submersible structure during transportation;

tethering the wave energy converter to the submersible structure via a tethering means operatively coupled to the submersible structure;

floating the submersible structure with the wave energy converter mounted thereon, the submersible structure having a buoyancy chamber sufficiently large that when filled with gas it enables the submersible structure to float;

transporting the wave energy converter to a site for deployment by towing the submersible structure with the wave energy converter mounted thereon; and,

launching the wave energy converter by releasing the gas from the buoyancy chamber so that the submersible structure submerges, and wherein the tethering means keeps the wave energy converter operatively coupled to the submersible structure during submersion.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the system and method of deploying a wave energy converter (WEC), given by way of example only, with reference to the accompanying drawings, in which:

FIG. 1 is a perspective view of a preferred embodiment of a system for deploying a WEC;

FIG. 2 is a partially transparent perspective view of a submersible barge structure employed in the system of FIG. 1;

FIG. 3 is a close-up view of a preferred embodiment of a tethering means employed in the system of FIG. 1;

FIG. 4 is a close-up view of the WEC and a preferred embodiment of the docking means provided on the system of FIG. 1; and,

FIG. 5 illustrates the WEC being launched using the system of FIG. 1.

### DETAILED DESCRIPTION OF PREFERRED EMBODIMENTS

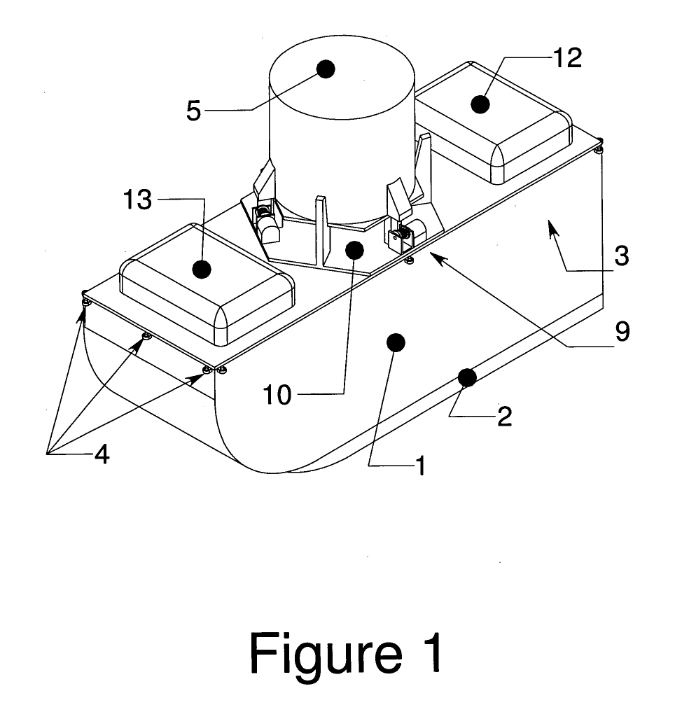

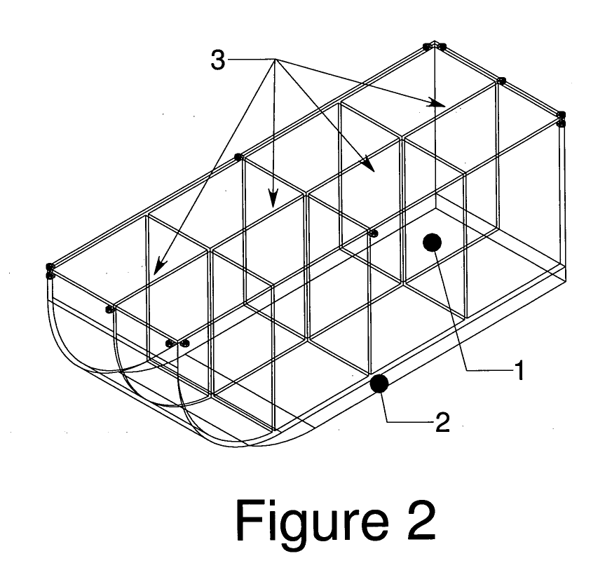

A preferred embodiment of a system for deploying, a wave energy converter in accordance with the invention, as illustrated in FIGS. 1 to 5, comprises a submersible structure in the form of a submersible barge structure 1. The barge structure 1 has a plurality of buoyancy chambers 3, with a combined capacity sufficiently large that when filled with gas they enable the barge structure 1 to float (see FIG. 2). In use, a wave energy converter (WEC) 5 can be mounted on the barge structure 1, transported to a site and launched by releasing the gas from the buoyancy chambers 3 and allowing them to fill with water. The WEC 5 is a basic buoy type WEC used for illustrative purposes. However the deployment system can also be used with other types of tethered wave energy converters.

The barge structure 1 preferably further comprises a ballast 2 with sufficient mass to act as a clump weight mooring for the WEC 5 when the buoyancy chambers 3 have been evacuated. Other mooring techniques may be used in conjunction with the clump weight to ensure the submerged barge 1 is anchored to the ocean floor; these may include sea anchors, pylons, and screw pylons.

A plurality of tow points 4 are preferably provided on the barge structure 1 to enable it to be coupled to a marine vessel (not shown) for towing the barge structure 1 out to sea. The tow points 4 are located at the bow, stern, and sides of the barge structure 1 to allow for easy access to the required tow vectors. Inbuilt compressed gas tanks 13 are provided for refilling the buoyancy chambers 3. Alternatively, an air hose (not shown) may be provided for connection to an external air supply. These air supplies will be used to expel the water within the buoyancy chambers 3 when refloating of the barge structure 1 is desired.

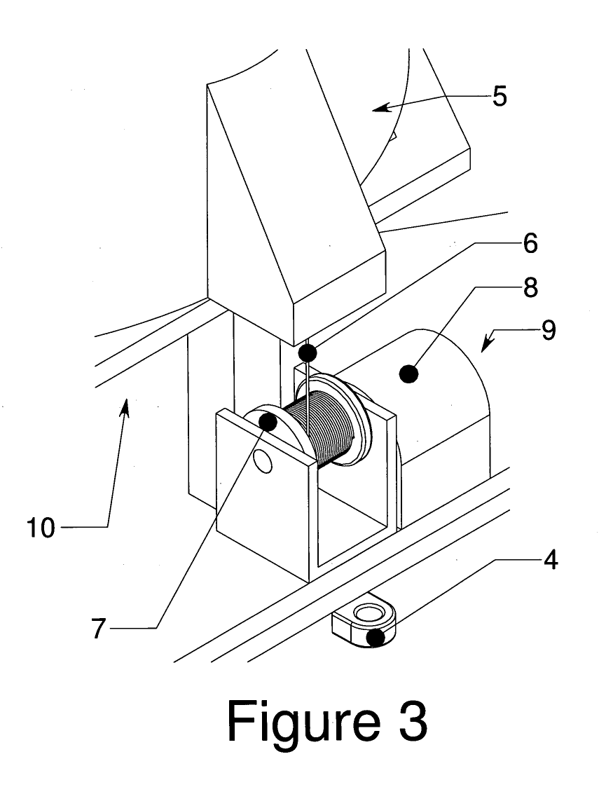

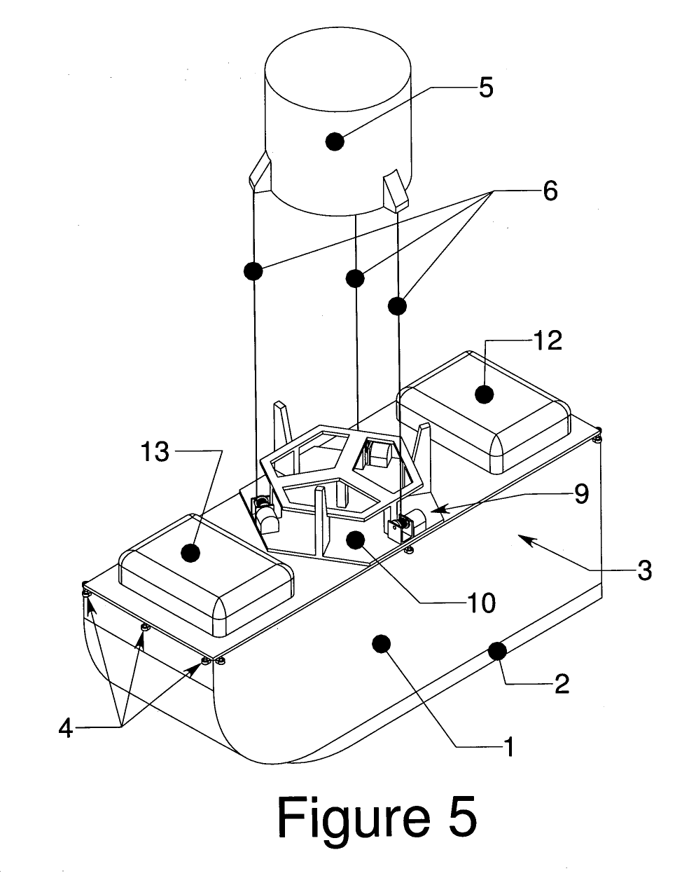

The system preferably further comprises a tethering means operatively coupled to the submersible barge structure 1 for tethering the WEC 5 to the barge structure 1. The tethering means of the illustrated embodiment comprises three tethers 6 (see FIGS. 3 and 5). The tethers 6 are used to connect the WEC 5 to the main barge structure 1 thus allowing the barge structure 1 to act as a mooring means when it is submerged. The tethers 6 also act as a means to attach the WEC 5 to the deck of the barge 1 when the barge is afloat.

The tethering means further comprises three tether winding assemblies 9 for winding the respective tethers 6 during deployment or retrieval of the WEC 5. Each tether winding assembly 9 comprises a spindle/winch 7 on which a respective tether 6 is wound. The spindle/winches 7 are used to keep a specific tension on the tethers 6 during the submersion and resurfacing of the barge structure 1. A second purpose of the tether winches 7 is to rewind the tethers 6 around the circumference of the respective spindles, thus preventing the drifting of the WEC 5 away from the barge deck during surfacing. A third purpose for the tether winches 7 is to keep the tethers 6 from straying and becoming a tangle hazard. A respective prime mover 8, for example, a hydraulic motor, is provided for driving the respective tether spindle/winches 7.

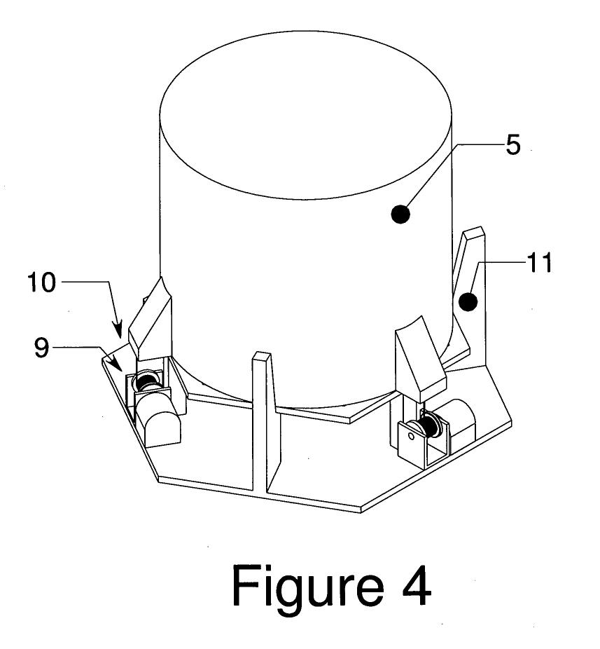

The deployment system preferably further comprises a docking station 10 provided in connection with an upper deck of the barge structure 1 for mechanically coupling the WEC 5 to the barge structure 1 during transportation. The WEC docking station 10 is a structure located on the barge's deck in which the WEC is located during transportation. The docking station 10 preferably prevents the WEC 5 from moving in a horizontal plane, whilst the tension applied to the WEC tethers will prevent motion in a vertical direction. Preferably the docking station 10 incorporates a guiding means that will facilitate an automatic alignment of the WEC 5 to the docking position in the WEC docking station 10. In the illustrated embodiment the guiding means comprises a plurality of projecting alignment guides 11 (See FIG. 4) which also act to inhibit horizontal movement of the WEC 5 in the docking position as shown in FIG. 4.

Preferably the system also includes a control and communications system 12 operatively connected to the tether assemblies 9 and buoyancy air release and refill system. The control and communications system 12 will be used to ensure the submersion and ascension of the barge structure 1 in a controlled manner; limiting the barge structure tilt to within acceptable limits. The communications system 12 will be used to provide feedback to the launching ship as well as providing the means to act as a remote control receiver for the launching and retrieval ship to instigate the systems submersion and re-floatation.

A preferred method of deploying the WEC 5, using the system described above will now be briefly described with reference to the accompanying drawings. The WEC 5 is mounted on the deck of the submersible barge structure 1 in the docking station 10. The barge structure 1 can then be towed behind a boat or other marine vessel, and when the desired location is reached the excess buoyancy within the barge buoyancy chambers 3 is released. The filling of the buoyancy chambers 3 with water causes the barge to submerge. During and after the submersion process the WEC 5 remains connected to the barge 1 through the tethers 6, which are wrapped around the spindle/winches 7. The spindles 7 are unwound at a rate designed to keep a constant tension on the tether lines 6. When the deployment is completed the spindles 7 can be either locked down to fix the tether lengths, or a dynamic control mechanism can be applied to the spindles 7, which would continually adjust the length of the tethers 6 to achieve a specific result.

The method of retrieval of the WEC 5 is the reverse of deployment. The barge 1 can be refloated through the refilling of the buoyancy tanks 3 with compressed gas/air, which would be controlled by remote means via the control and communications system 12. During the refloating process constant tension is applied to the tethers 6 through the spindles 7 via suitable means such as pneumatic, hydraulic, or electric prime movers attached to the spindles. This tension on the tethers 6 causes the tethers to be wound around the spindle's circumference as the barge 1 ascends, thus removing the possibility of tether entanglement. Through the constant tension on the tethers 6 the WEC 5 will remain located over the barge 1 during the ascension of the barge until such time as the WEC 5 returns to its docking station 10 on the barge deck. The remainder of the water would then be purged from the buoyancy tanks 3, which would make the barge and the now attached WEC 5 ready for towing by the transport ship.

Now that a preferred embodiment of the system and method of deploying a WEC have been described in detail, it will be apparent that it provides a number of advantages over the prior art, including the following:

It allows a WEC to be deployed over a wide variety of sea-states as well as ocean depths.

(ii) It lends itself to being fully automated and remotely controllable.

(iii) It is possible to incorporate a host of features that make it possible to remotely control the commissioning and retrieval of the WEC from a safe location, without the use of commercial divers.

It will be readily apparent to persons skilled in the relevant arts that various modifications and improvements may be made to the foregoing embodiment, in addition to those already described, without departing from the basic inventive concepts of the present invention. For example, the WEC may alternatively be tethered via a single tether to the barge. In the description and accompanying drawings of the preferred embodiment of the system there is only one WEC attached to the mooring system. However it is a function of the system that there could be more than one mooring system attached to a single WEC or that there could be more than one WEC attached to a single mooring system. Therefore, it will be appreciated that the scope of the invention is not limited to the specific embodiments described.

1. A system for deploying a wave energy converter, the system comprising:
a submersible structure having a buoyancy chamber sufficiently large that when filled with gas it enables the submersible structure to float wherein, in use, a wave energy converter can be transported to a site on the submersible structure and launched by releasing the gas from the buoyancy chamber;
a tether operatively coupled to the submersible structure for tethering the wave energy converter to the submersible structure; and,
a docking station provided in connection with the submersible structure for mechanically coupling the wave energy converter to the submersible structure during transportation.

2. A system for deploying a wave energy converter as defined in claim 1, wherein the submersible structure is a barge structure having a plurality of buoyancy chambers provided therein.

3. A system for deploying a wave energy converter as defined in claim 2, wherein the barge structure has a plurality of tow points provided thereon to enable it to be coupled to a marine vessel for towing the barge structure out to sea.

4. A system for deploying a wave energy converter as defined in claim 2, wherein the barge structure further comprises a ballast with sufficient mass to act as a clump weight mooring for the wave energy converter when the buoyancy chambers have been evacuated.

5. A system for deploying a wave energy converter as defined in claim 1, wherein the tether comprises a plurality of tethers.

6. A system for deploying a wave energy converter as defined in claim 5, wherein the tethers connect the wave energy converter to the barge structure thus allowing the barge structure to act as a mooring when submerged.

7. A system for deploying a wave energy converter as defined in claim 5, wherein the tether further comprises a plurality of tether winding assemblies for winding the tethers during deployment or retrieval of the wave energy converter.

8. A system for deploying a wave energy converter as defined in claim 7, wherein each tether winding assembly comprises a spindle or winch on which a respective tether is wound.

9. A system for deploying a wave energy converter as defined in claim 8, wherein the spindle or winch is used to keep a specific tension on the tethers during the submersion and resurfacing of the barge structure.

10. A system for deploying a wave energy converter as defined in claim 1, wherein the docking station incorporates a guide to facilitate automatic alignment of the wave energy converter to the docking position in the docking station.

11. A system for deploying a wave energy converter as defined in claim 10, wherein the guide comprises a plurality of projecting alignment guides which also act to inhibit horizontal movement of the wave energy converter in the docking position.

12. A method of deploying a wave energy converter, the method comprising the steps of:
docking a wave energy converter in a docking station provided in connection with an upper surface of a submersible structure, the docking station mechanically coupling the wave energy converter to the submersible structure during transportation;
tethering the wave energy converter to the submersible structure via a tether operatively coupled to the submersible structure;
floating the submersible structure with the wave energy converter mounted thereon, the submersible structure having a buoyancy chamber sufficiently large that when filled with gas it enables the submersible structure to float;
transporting the wave energy converter to a site for deployment by towing the submersible structure with the wave energy converter mounted thereon; and,
launching the wave energy converter by releasing the gas from the buoyancy chamber so that the submersible structure submerges, and wherein the tether keeps the wave energy converter operatively coupled to the submersible structure during submersion.

13. A method of deploying a wave energy converter as defined in 12, wherein the tether comprises a tether line wound about a tether winding assembly and wherein the tether line is unwound at a rate designed to keep a constant tension on the tether.

14. A method of deploying a wave energy converter as defined in 13, wherein when the deployment is completed the tether winding assembly is locked down to fix the tether line length.

15. A method of deploying a wave energy converter as defined in 13, wherein when the deployment is completed a dynamic control mechanism is applied to the tether winding assembly, which continually adjusts the length of the tether line to achieve a specific result.

16. (canceled)

17. (canceled)
